(19) United States
(12) Patent Application Publication
(10) Pub. No.: US 2017/0224093 A1
(43) Pub. Date: Aug. 10, 2017

(54) WEARABLE HEADLIGHT HOLDER ASSEMBLY

(71) Applicant: George Yao, Irving, TX (US)

(72) Inventor: George Yao, Irving, TX (US)

(21) Appl. No.: 15/016,835

(22) Filed: Feb. 5, 2016

(51) Int. Cl. A45F 5/02; A41D 20/00; F21V 21/08; A45F 5/00

(52) U.S. Cl. CPC A45F 5/02; A45F 5/00; A41D 20/00; F21V 21/0832

(57) ABSTRACT

A wearable headlight holder assembly includes a central rectangular webbing with two stretchable rings extending at distal ends, and a strip of Velcro sewed to the center of said webbing and used to detachably strap the webbing to a headband. The headlight holder assembly allows for the placement of a light source though the two stretchable rings and allows the user to illuminate a chosen area. The present design are more flexible to fit headlights with various sizes and cost-effective to manufacture. The flexible design also allows it to be attached to a headband, a clothing, belt, or forearm for uses including but not limited to exercising, repairs or camping.

### TECHNICAL FIELD

The inventions disclosed herein generally relate to flashlight holder assembly, and more particularly to the new and improved headlight holding assembly that is cost-effective to manufacture and more flexible to fit into various usage scenarios of a headlight.

### BACKGROUND OF THE INVENTION

An examination of prior art reveals several designs of headband assemblies for mounting a flashlight on the head. For example, U.S. Pat. No. 3,249,271, utilizes a rigid headband where the user must use a thumbscrew to adjust the size of the headband, but lacks the means to horizontally adjust the piece. U.S. Pat. No. 4,462,064 describes a flashlight headband with a tubular-shaped clip for holding a flashlight. The clip is fixed to the headband and its location cannot be adjusted. It provides no means for vertical adjustment of the flashlight beam and no means for size adjustment. U.S. Pat. No. 4,508,249 describes a way to attach a flashlight to a person's arm, but is not designed for mounting a flashlight to a person's head. When attached to the forearm, only three positions of angular adjustment are allowed, thus again lacking many adjustment options. U.S. Pat. No. 4,729,499 is a perforated headband allowing for multiple flashlights, but only allows for adjustment of circumference of the headband. All of the aforementioned prior art are limited in some aspects.

In the course of everyday life, people may need to utilize their hands and an alternate light source at the same time. Headlights are useful in these situations where both hands must be free. Because people are unable to hold the light and work with their hands simultaneously, they need to be able to wear the light source. Light sources mounted upon an individual's head have been used for many years in the field of mining for the purpose of illuminating the miner's work area. More modern day needs can arise when a person is performing maintenance whether it be under the sink, in the attic, or underneath a vehicle. A need can occur when a person is up early in the morning or late at night exercising outside. A need can occur when a person is camping or hiking in the late evenings. A need can occur when people travel, and happen to visit a cave, mine, or dark place where light is needed. A need can occur for something as basic as a reading light. In order to meet all of these specific needs, the light source needs to be very versatile. The traditional method used for an individual to wear a light source and have their hands free at the same time is to attach a light to a head piece or an assembly that can be attached to a forearm. However, because of the rigidness and bulkiness of prior art, performing the aforementioned examples of tasks can be very inconvenient, and it is further necessary to not have enough light or not have the light in the correct location, which can cause make performance of these tasks daunting, thus causing the resulting work product to be poor. While many designs for headlamp holders exist in the prior art, there still exists a need for a more versatile headlight holder which can be adapted to be used in a multitude of scenarios.

In order to overcome the above-described flaws with alternative light source used for tasks, various types of headlight apparatuses have appeared on the market, some of which allow for multiple flashlights to be attached, and others of which allow for adjustment of the illumination angles in order to be more efficient. Currently-existing headlight apparatuses tend to be singular assemblies which do not come apart, and are often rigid and bulky, which creates a great deal of inconvenience for the user. During usage, often the assembly cannot be adjusted horizontally, vertically, or angularly, which is another inconvenience.

### SUMMARY OF THE INVENTION

The headlight holder assemblies disclosed herein relate to targeting the above-described flaws of currently-existing techniques, and providing a wearable, flexible headlight assembly, thus overcoming the flaw of not being able to adjust the headlight once in place. The present invention discloses new and improved headlight holder assembly for use with a user's choice of attachment piece, whether it be a headband or other support members. The headlight holder device includes a central rectangular webbing with two stretchable rings extending at distal ends, and a strip of Velcro sewed or otherwise securely attached to the center of said webbing and used to detachably strap the webbing to a headband. The headlight holder assembly allows for the placement of a light source though the two stretchable rings and allows the user to illuminate a chosen area. The present design are more flexible to fit headlights with various sizes and cost-effective to manufacture. The flexible design also allows it to be attached to a headband, a clothing, belt, or forearm for uses including but not limited to exercising, repairs or camping.

The present inventions providing a wearable, adjustable headlight holder assembly including a strip of Velcro; the described strip of Velcro is attached to a fabric webbing which has attached to it two stretchable rings; the described strip of Velcro includes a fabric strip with loops and an attachment strip with attachment hooks.

Further improvements of this design are: the described fabric webbing may be placed on any desired location.

A further improvement of the present inventions is: the two rings attached to the webbing are stretchable and can be sized differently to fit various sizes of light sources.

A further improvement of the present inventions is: the addition of the Velcro strip attached to the webbing, the Velcro strip may be adjusted as well as the entire webbing, by being removed from the chosen attachment location.

A further improvement of the present inventions is: the described strip of Velcro allows for attachment to any chosen location.

The positive effect of this invention is: the webbing may be detached and placed where user desires for attachment. The adjustable Velcro strip allows for attachment where user desires for attachment whether it be to a headpiece, a t-shirt, or around the user's arm. The stretchable rings allow for different sizes of light sources to be used. Ultimately the user has more flexibility in where and what light source they can utilize, thus being more efficient. There are a multitude of adjustment options, thus providing great convenience to the user. The assembly is completely portable and versatile, allowing for maximum usage. Also, there is no need to occupy any additional space because the assembly is not bulky and the assembly is easy to transport.

### BRIEF DESCRIPTION OF THE DRAWINGS

FIG. 1 depicts a three-dimensional structural illustration of a preferred embodiment with a central rectangular webbing with two stretchable rings attached at distal ends;

FIG. 2 depicts a three-dimensional structural illustration of a preferred embodiment with a rectangular webbing with two stretchable rings attached at distal ends, and a Velcro strip which contains both a fabric strip with tiny loops and an attachment strip with tiny flexible hooks;

FIG. 3 depicts a three-dimensional structural illustration of a preferred embodiment that includes a head band;

FIG. 4 depicts a three-dimensional illustration of the use of a preferred embodiment;

FIG. 5 depicts a three-dimensional illustration of the use of a preferred embodiment as attached to the left front chest of a uniform clothing;

FIG. 6 depicts a three-dimensional structural illustration of a prior art design.

FIG. 7 depicts a three-dimensional structural illustration of a prior art design.

### DETAILED DESCRIPTION

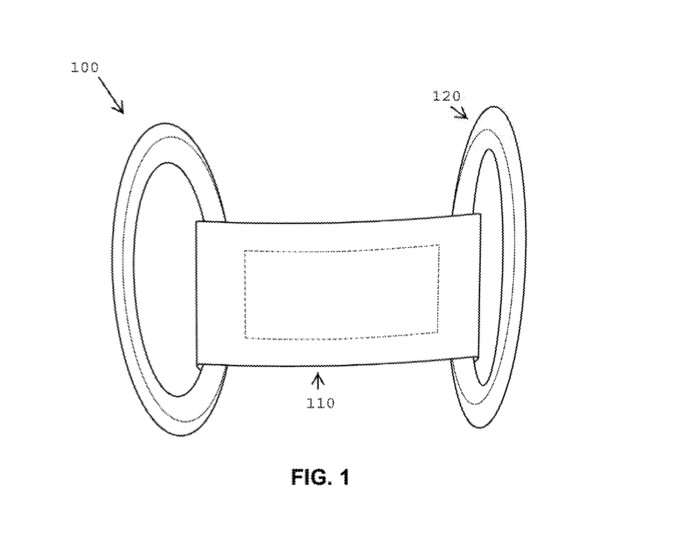

FIG. 1 depicts a preferred embodiment 100 that includes a rectangular fabric webbing 110 with two stretchable rings 120 attached at distal ends. The described rectangular fabric webbing 110 has an inner rectangle to illustrate the stitching of the fabric. The two stretchable rings 120 are located one at each distal end of the webbing. Each stretchable ring 120 is made of rubber. Each stretchable ring is securely attached to the webbing by sewing thread or other applicable means. The rectangular fabric webbing 110 is designed to lay flat for better attachment. It easily attaches to a head piece allowing for a flat, flush fit to the user's head. The described stretchable rings 120 allow for multiple sizes of light sources to be received and held. The sizes of the two rings are generally the same, but could be different sizes if need to fit special types of headlight. Once inserted into the two stretchable rings, the light source rests against the rectangular webbing. The light source is secured into the rings by the elasticity of the material. The fact that a ring holds down the light source at each end precludes the light source from being dislodged or emitted from the headlight holder assembly. A webbing made of other material are also applicable as long as they are made of strong and tightly woven material capable of supporting, catching or hold things.

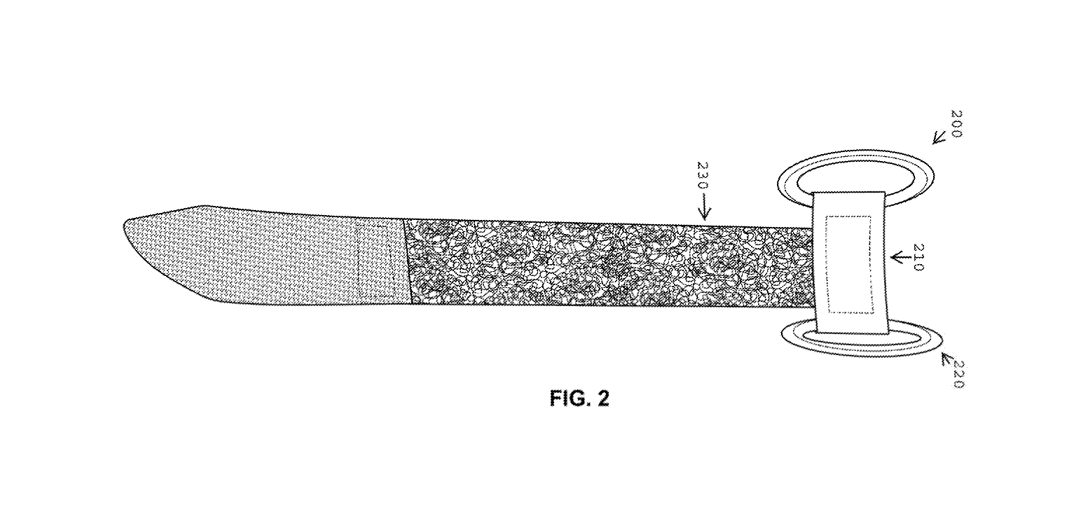

As shown in FIG. 2, this preferred embodiment 200 includes a rectangular webbing 210 with two stretchable rings 220 attached at distal ends, and a Velcro strip 230 which contains both a fabric strip with tiny loops and an attachment strip with tiny flexible hooks. The user determines the proper location of attachment and the circumference of attachment with the Velcro strip 230. The user is able to attach the fabric strip with loops on one side of the Velcro to the attachment strip with hooks on the opposite side of the Velcro at whatever distance apart need be to fit the desired location. This allows for optimal adjustability and attachment of the headlight holder assembly. Additionally, the user may attach the assembly to a headpiece by wrapping and attaching the Velcro strip around the headpiece or the user may attach the assembly to the user's forearm but using the same method with the Velcro strip. The user may even attach the assembly to a belt or a pole, anything the Velcro strip can fasten around, which is very convenient to the user needing a positioned light source. This range of adjustment and versatility allows the flashlight to be used effectively in a variety of ways.

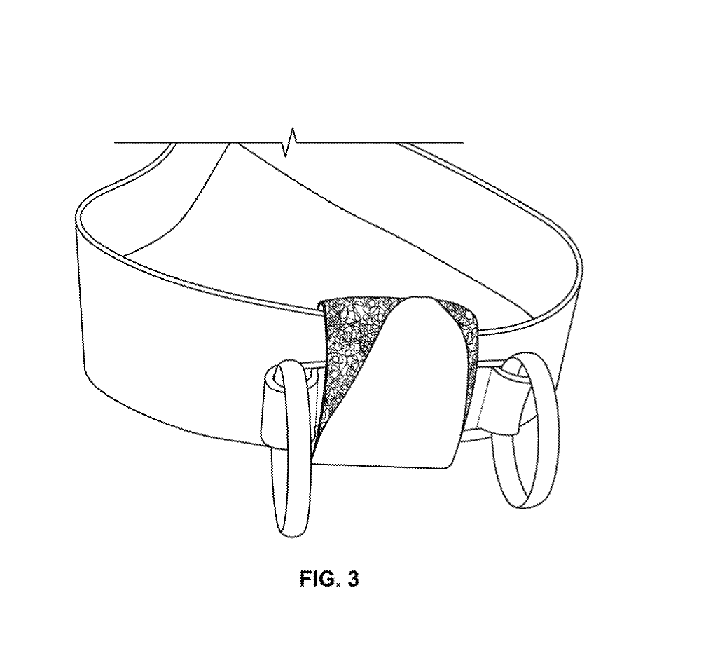

FIG. 3 shows an exemplary headlight holder assembly attached to the headpiece. In order to attach, the user must wrap the attachment loop portion of the Velcro strip around first the desired portion of the headpiece to be attached to, and then also wrap it around the webbing, and ultimately back to fasten with the attachment hook portion of the Velcro piece for secure attachment. Once attached the Velcro strip lays flat in the center of the webbing, which still allows room for the light source to be received through the stretchable loops and lay on top of the Velcro strip fastening.

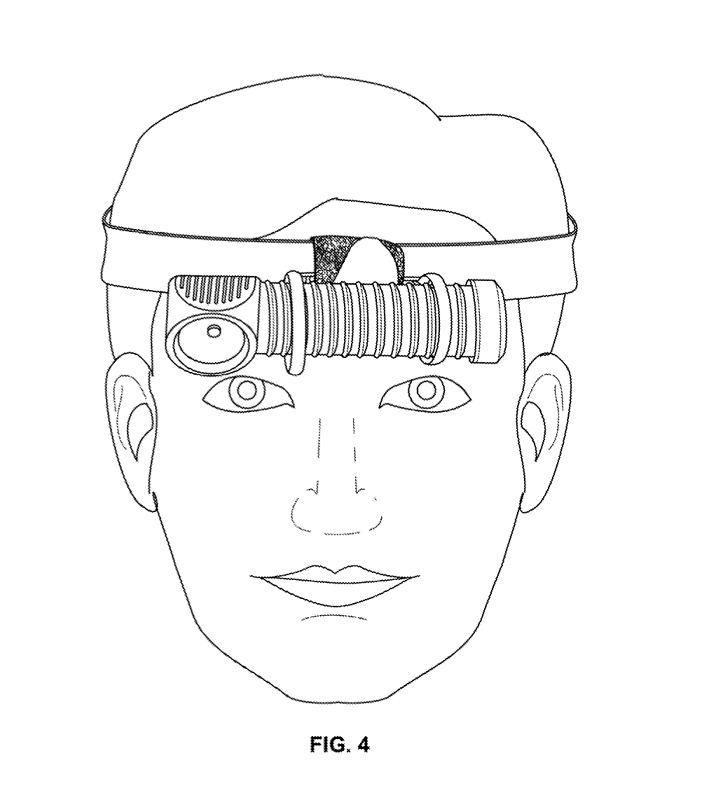

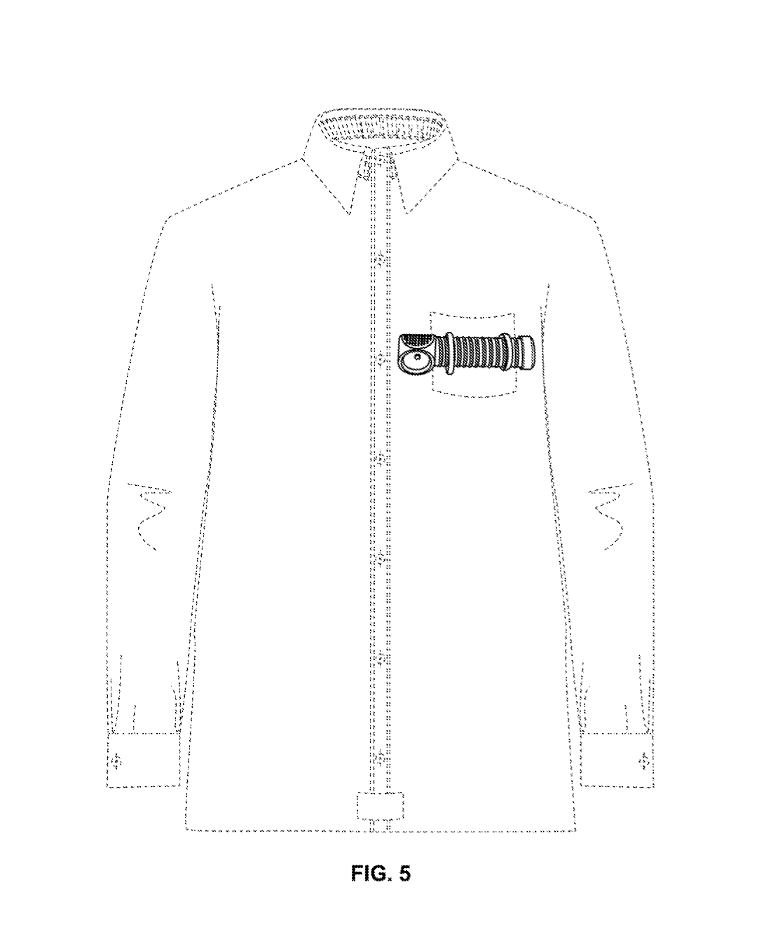

FIGS. 4-5 are examples of usage of two preferred embodiment. Specifically FIG. 4 shows a preferred embodiment with a Velcro strip attached to a headpiece and worn on the user's forehead. It shows the light source being received and held by the two stretchable rings, sitting on top of the attached Velcro strip. FIG. 4 the exemplary headlight holder assembly being worn in the center of the headpiece, but this can easily be altered to either side of the headpiece depending on the user's specific need at the time of use. FIG. 5 depicts the headlight holder assembly being worn on the left front chest portion of a uniform. This is another option the user has. This preferred embodiment does not include a Velcro strip. One can simply sew or otherwise securely attached the webbing to the front of the clothing. The versatility of this design allows the user to attach the assembly to a multiple of locations. Some locations such as the head or arm, allow the user to wear the assembly, but this design is not limited to wear by the user, it may also be attached to stationary objects such as a pole or chair for use.

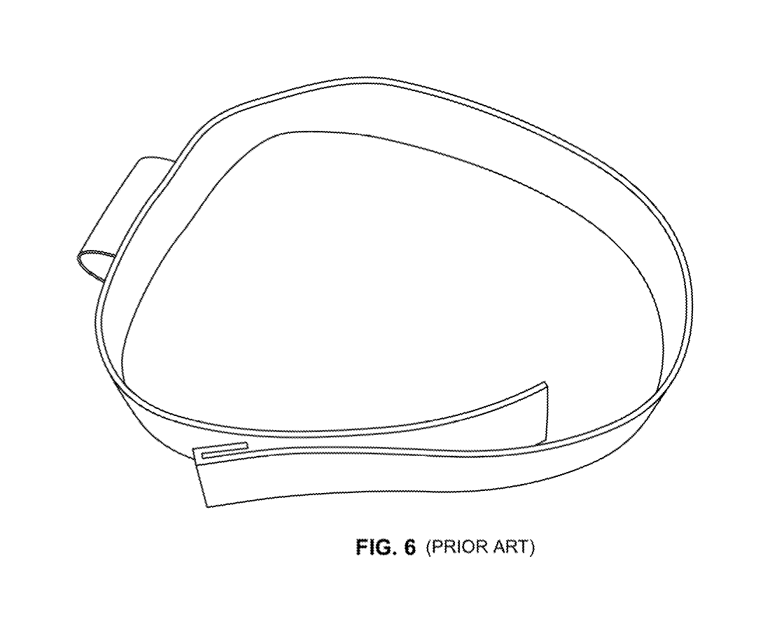

FIG. 6 depicts a prior art headband. This piece does not allow for the user to choose where to attach the assembly, but rather this piece must be inserted in the fixed tubular-shaped clip. It does not have the flexible as the present design.

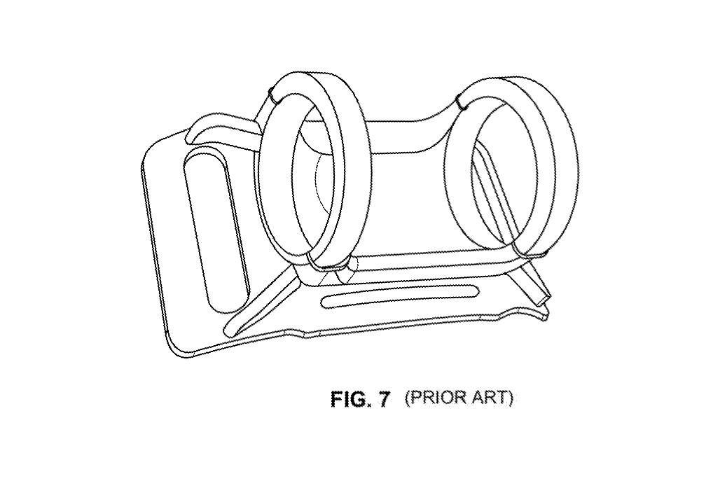

FIG. 7 depicts a prior art headlight holder. It's generally made of rubber, which lacks the flexibility to hold headlights with different body sizes. The headlight holder includes two openings on both sides that allow a headband to be inserted to hold the headlight holder. Again, it is not as flexible or comfortable to wear as the present inventions.

Although exemplary embodiments of the assembly of the present invention have been illustrated in the accompanied drawings and described in the foregoing detailed description, it will be understood that the invention is not limited to the embodiments disclosed, but is capable of numerous rearrangements, modifications, and substitutions without departing from the spirit of the invention as set forth and defined by the following claims. Further, although depicted in a particular manner, various modules or blocks may be repositioned without departing from the scope of the current invention.

What is claimed is:

1. A wearable headlight holder assembly compromising:
a webbing with a size suitable to cover a body portion of a wearable headlight;
a first stretchable hollow ring securely fixed to one end of said webbing;
a second stretchable hollow ring securely fixed to the other end of said webbing; and
wherein the two hollow rings are configured to tightly hold the body portion of a wearable headlight.

2. A wearable headlight holder assembly according to claim 1 further comprises a Velcro strip securely attached to the center of said webbing and can be used to detachably strap the webbing to a headband.

3. A wearable headlight holder assembly according to claim 1 further comprises one or more fasteners designed to securely attach said webbing to a uniform clothing.

4. A wearable headlight holder assembly as described in claim 1, wherein said two stretchable hollow rings are attached at the distal ends of said webbing.

5. A wearable headlight holder assembly as described in claim 1, wherein said stretchable hollow rings are made of rubber.

6. A wearable headlight holder assembly as described in claim 1, wherein said first and second rings are different sizes designed to fit headlight with different shapes.

7. A wearable headlight holder assembly as described in claim 1 further comprises a headband securely attached to said webbing.

8. A wearable headlight holder assembly as described in claim 6 further comprises a headlight suitable to be inserted into said first and second hollow rings.
